(19) United States
(12) Patent Application Publication
(10) Pub. No.: US 2008/0241440 A1
(43) Pub. Date: Oct. 2, 2008

(54) Detachably-Affixable, Flat Components, in Particular Floor Covering Parts, and Component

(76) Inventor: Jorg R. Bauer, Weingarten (DE)

Correspondence Address: MICHAEL BEST & FRIEDRICH LLP, 100 E WISCONSIN AVENUE, Suite 3300, MILWAUKEE, WI, 53202, US

(21) Appl. No.: 12/064,067

(22) PCT Filed: Aug. 17, 2006
(86) PCT No.: PCT/EP2006/008120

§ 371 Date: Feb. 18, 2008

(30) Foreign Application Priority Data
Aug. 19, 2005 (DE) 10 2005 039 369.1
Dec. 13, 2005 (DE) 10 2005 059 540.5

(51) Int. Cl. F16B 5/07

(52) U.S. Cl. 428/33

(57) ABSTRACT

The invention relates to detachable, flat components (10, 12) that can be fastened to each other, in particular floor covering components. Each of said components has an edge region and said regions fit together by the displacement of the components in relation to one another, in such a way that the components, which lie on a common plane, are protected against becoming detached on said plane. The edge regions are configured as projections (14, 16), which lie one above the other in relation to their common plane when fastened to each other, in such a way that the components can be fastened to each other by means of an essentially linear relative displacement that is perpendicular to the common plane.

The invention concerns detachably-affixable, flat components, in particular floor covering parts. The invention further concerns one of the detachably-affixable components.

Parquet floors, which are assembled from individual, mostly rectangular floor elements, are conventionally installed by pushing tongues into grooves that are formed on the edge portions; the grooves and tongues are glued together. Recently, so-called click parquets have become popular, in which a projection is formed on an edge portion of one parquet element and a recess is formed on an adjacent edge portion of the adjacent parquet element; the projection and recess are formed with engagement surfaces, such that the projection is inserted into the recess and can be brought into a form-fit engagement by inward pivoting, such that a separation of the connected-together parquet elements is not possible when they are supported on a substrate. Such a click parquet is described, for example, in WO 97/47834. The contour of the recesses and projections is relatively complicated.

The object underlying the invention is to provide detachably-affixable, flat components, in particular floor covering parts, which permit a secure, mutual attachment with a simple construction.

Solutions of this object are achieved with the features of patent claims 1 and 6, which are further developed in an advantageous manner with the features of the dependent claims that refer back to them.

In the following, the invention will be explained in an exemplary manner with the assistance of schematic drawings and with further details.

In the Figures:

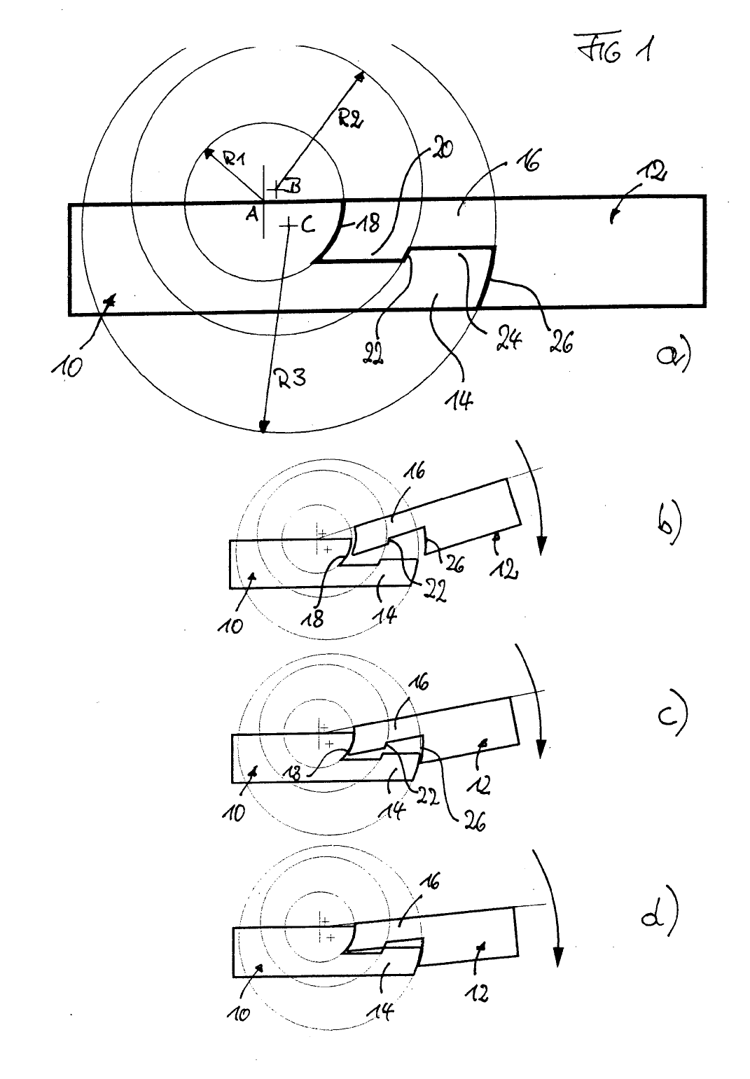

FIGS. 1 to 6 show cross-sectional views of six different components of detachably-affixable components,

FIGS. 7 to 13 show views of floors, as they can be laid with the inventive components,

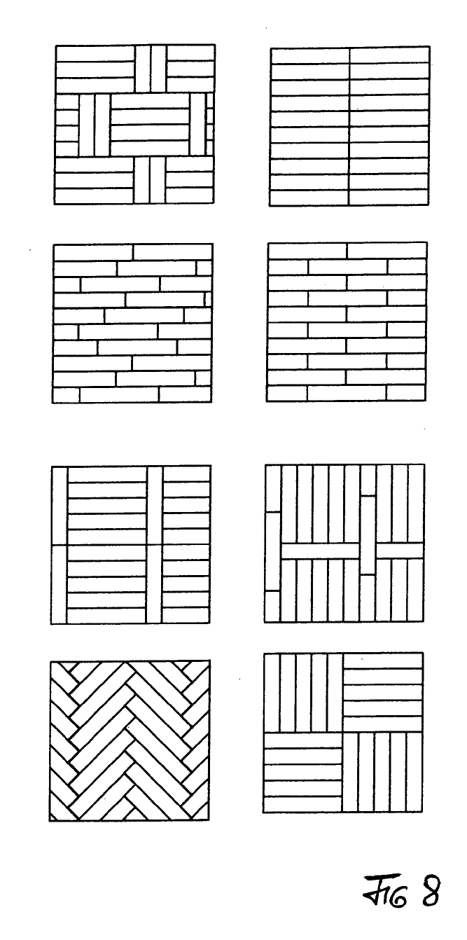

FIG. 14 shows a schematic perspective view for explaining the manufacturing of an edge portion,

FIG. 15 shows a partial cross-sectional view of a flat component for explaining further details,

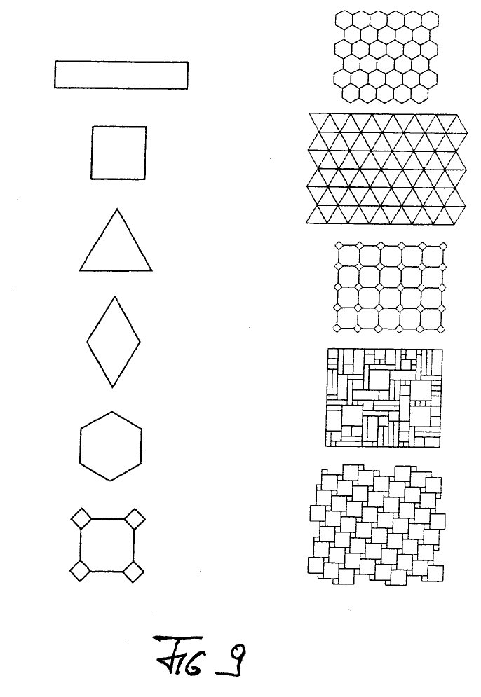

FIG. 16 shows two detachably-affixable, flat components according to FIG. 15,

FIG. 17 shows a further exemplary embodiment of detachably-affixable, flat components,

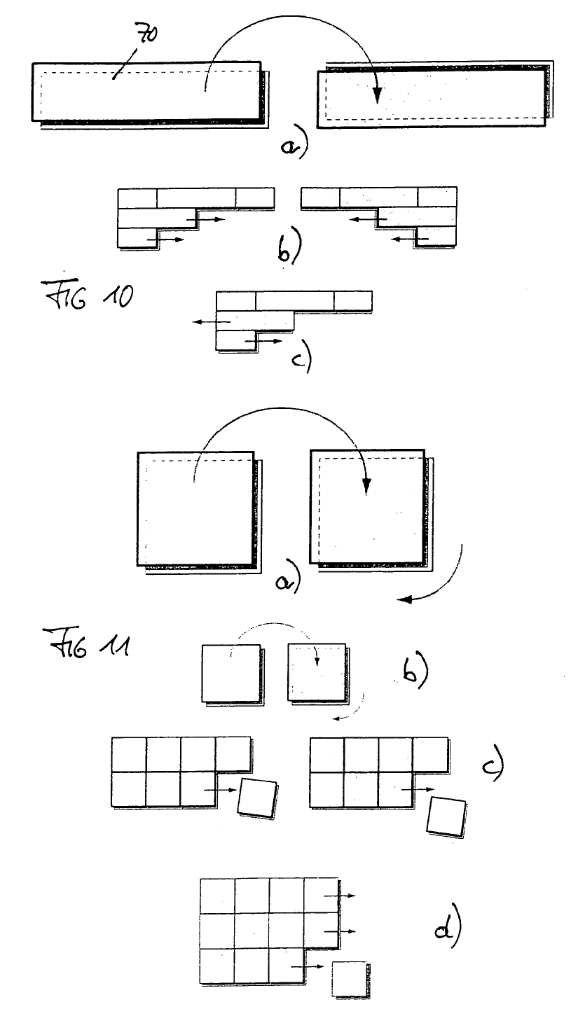

FIGS. 18 to 20 shows differing embodiments of flat components,

FIG. 21 shows components that are provided with edge portions in differing ways,

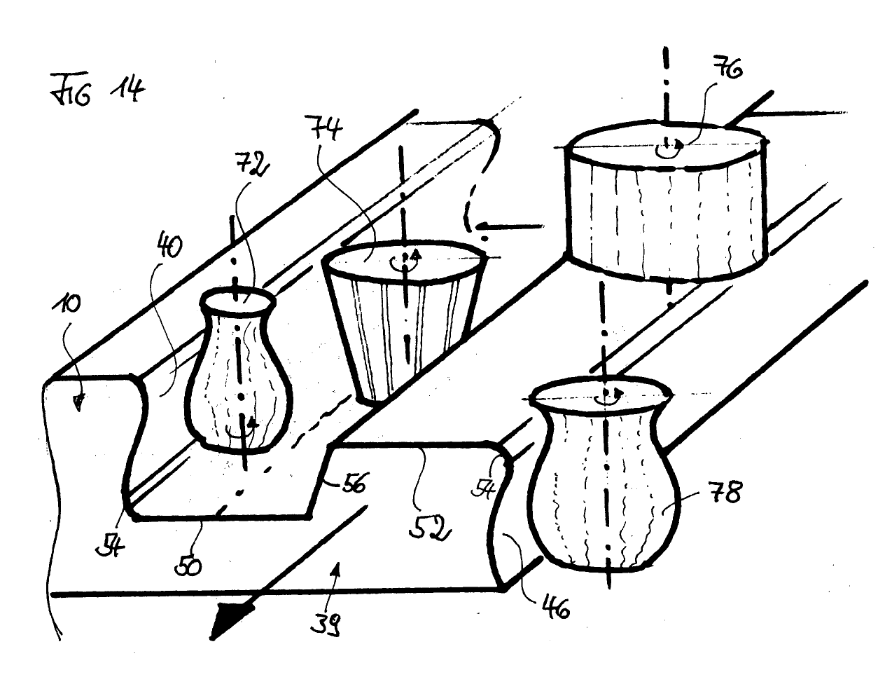

FIGS. 22 to 25 show differing embodiments of flat components having means for their attachment to a substrate,

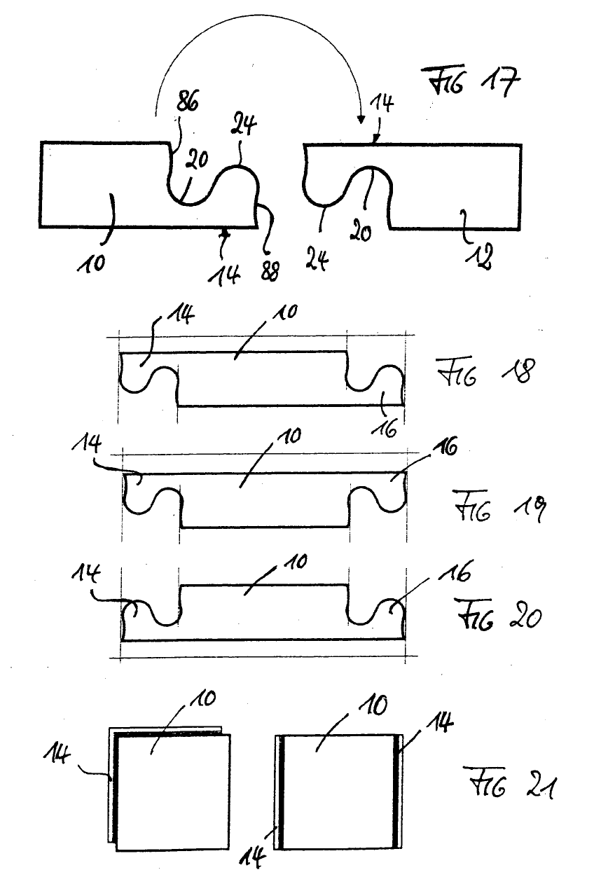

FIGS. 26 and 27 show flat components provided with coatings,

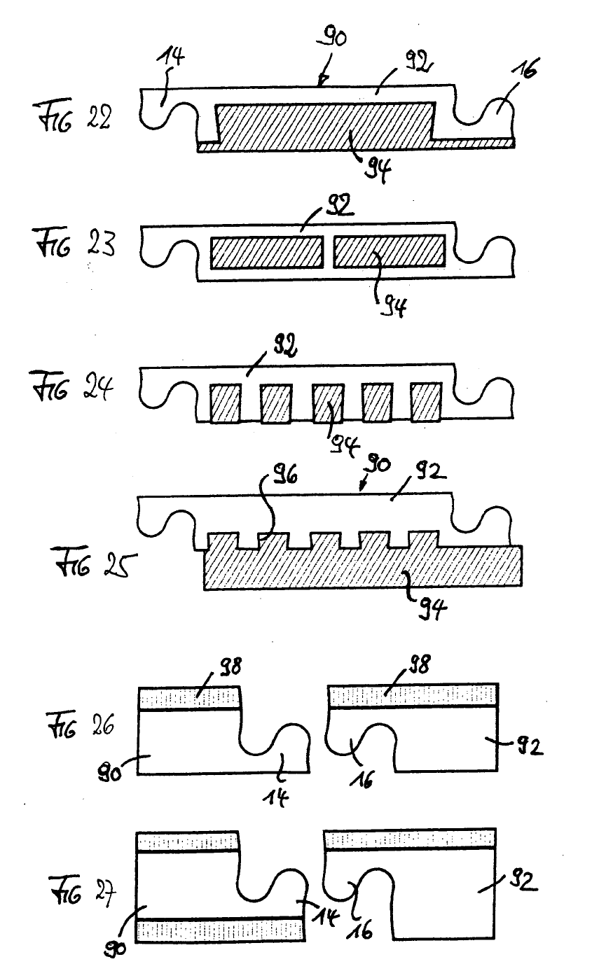

FIG. 28 shows a flat component provided with a strut,

FIG. 29 shows the production of a wood floor from components according FIG. 28,

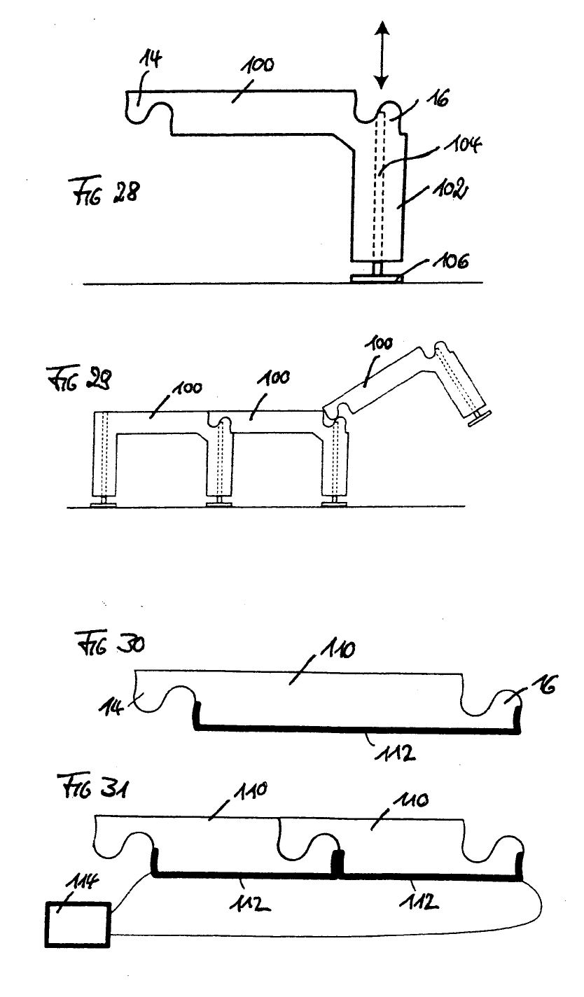

FIG. 30 shows a component provided with an electrically-conductive layer, and

FIG. 31 shows assembled, flat components that are electrically-conductive.

The invention will be explained using the example of parquet floors. The invention is also usable for wall panels, ceiling panels and more generally for the detachable, mutual attachment of components, which are brought into a mutual form-fit by relative movement towards each other in one or more directions, wherein this form-fit is not detachable by moving the components apart in a direction that is different from the direction(s) in which the components were connected.

In part a), FIG. 1 shows two flat components 10 and 12, which are attached to each other by a form-fit and which are formed, e.g., as parquet elements. The components 10 and 12, which lay upon a not-illustrated, planar substrate, e.g., a sound insulation pad, have the same thickness, so that their upper sides extend towards each other in a flush manner. A projection 14 is formed on the component 10; in the connected-together state of the components, the projection 14 is entirely disposed underneath a projection 16 formed on the other component 12.

The upper side of the component 10 transitions via a first, overall circular-cylinder-segment-shaped engagement surface 18 into a recess 20. The recess 20, whose upper side is approximately planar and parallel to the substrate, transitions via a second engagement surface 22 into an elevation 24, whose upper side likewise extends approximately parallel to the non-illustrated floor surface and transitions via a third circular-cylinder-segment-shaped engagement surface 26, which forms the front face of the projection 14, into the planar underside of component 10.

The component 10, e.g., a parquet piece, is overall rectangular and cut perpendicular to its longitudinal direction. The first engagement surface 18 forms a part of the outer surface of a circular cylinder, whose center line A is disposed, in the illustrated example, on the upper side of component 10; this cylinder has a radius R1. The concave, first engagement surface extends, in the illustrated example, approximately over an angular interval such that the thickness of the projection 14 in the area of the recess 20 corresponds to approximately half of the thickness of component 10.

The second engagement surface 22 is a segment of an outer surface of a second circular cylinder, whose center line B is disposed, in the Figure, right of the center line A of the first circular cylinder and somewhat above the center line A. The radius R2 of the second circular cylinder is larger than the radius of the first circular cylinder. The angular interval, over which the second engagement surface extends, is set such that the thickness of the projection 14 in the area of the elevation 24 is somewhat larger than half of the entire thickness of component 10.

The circular cylinder, to which the third engagement surface 26 belongs, has a center line C, which is below the center line B and right of the center line B according to FIG. 1. The radius R3 of the third circular cylinder is larger than the radius R2.

The projection 16 of the other component 12 is formed such that, as is apparent from FIG. 1, the projection 16 completely fills the space above the projection 14 when the components 10 and 12 are connected together in a form-fit manner, so that the upper sides of the two components form a planar surface. More particularly, the projection 16 includes engagement surfaces that correspond to the engagement surfaces 18, 22 and 24, wherein corresponding engagement surfaces flatly abut on each other in the connected-together state of the components 10 and 12.

The assembly and/or form-fit connecting of the components 10 and 12 will be explained with the assistance of Figure parts b)-d). As illustrated, the component 12 with its projection 16 is obliquely inserted from above into the space above the projection 14, until the first engagement surface 18 arrives in abutment with the concentrically-corresponding engagement surface located on the front face of the component 12. The engagement surface 18 and the concave opposing surface on the front face of projection 16, which surfaces are in mutual abutment, form a guide; the guide guides the pivoting of component 12, which pivoting takes place about the center line A, until the second engagement surface 22 and the third engagement surface 26 move along their opposing surfaces and come into flat mutual abutment, as illustrated in FIG. 1a) when the component 12 is completely lowered.

As is apparent from the Figures, the distance between the first circular cylinder (center line A) and the second circular cylinder (center line B) decreases due to their positions eccentric to each other, so that the first engagement surface 18 and the second engagement surface 22 only come into clearance-free, flat, mutual abutment when the component 12 is completely lowered. Similarly, the distance between the second circular cylinder and the third circular cylinder decreases due their eccentric arrangement, such that, when lowering and/or downward-pivoting the component 12, the engagement surface 22 and the engagement surface 26 only come into clearance-free, flat, mutual abutment with the corresponding engagement surfaces of the projection 16 when the component 12 is completely lowered. The flat abutment, which results due to the eccentric arrangement of the cylinders and only occurs at the end of the downwards pivoting, facilitates the pivoting and achieves a freedom from play of the engagement between the projections, wherein the second engagement surface 22 effects a form-fit with the associated opposing surface of the other projection 16 in the direction of separation of the components from each other (movement of component 12 towards the right), whereas the first engagement surface 18 and the third engagement surface 26 form undercuts, which do not allow movement of component 12 vertically upward relative to component 10.

The engagement surfaces are not required to be parts of circular cylinders; they could also be parts of elliptical cylinders or other cone sections, wherein the first engagement surface 18 must be concave, the second engagement surface 22 must be convex and the third engagement surface 26 must be concave and they are advantageously designed such that the distance between the first engagement surface 18 and the second engagement surface 22, which distance is measured horizontally as shown in FIG. 1, decreases in the direction towards the upper side of the recess 20 and the distance between the second engagement surface 22 and the third engagement surface 26 reduces in the direction towards the upper side of elevation 24. In the area of the surfaces of the projections, which surfaces are not formed as engagement surfaces, clearances can remain that accommodate any possible dirt. However, a mutual abutment is advantageous also in these areas, so that the sturdiness of the connected-together components 10 and 12 with respect to vertical impacts in the area of the projections, which are disposed one above the other, is equally large as outside of the projections. In a simplified embodiment, the center lines of all circular cylinders can coincide with center line A.

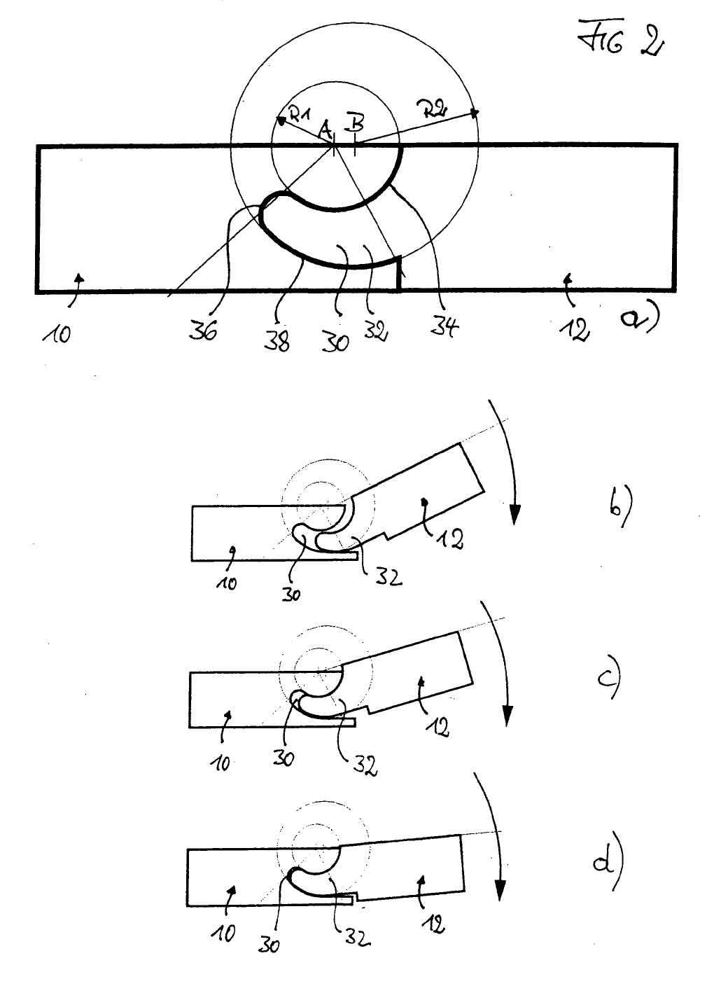

FIG. 2 shows a modified embodiment of a detachable connection between the components 10 and 12, in which circular-cylinder-segment-shaped engagement surfaces likewise achieve the form-fit.

In the illustrated example, a recess 30 is formed on the right edge of component 12; a corresponding projection 32 of component 12 engages in the recess 30. The upper side of the recess 30 forms a circular-cylinder-segment-shaped, first engagement surface 34, wherein the center line A of the corresponding cylinder lies on the upper side of the component 10 in the illustrated example. The convex, first engagement surface 34 transitions via a sharply-curved transition region 36 into a second, circular-cylinder-segment-shaped engagement surface 38, which extends to the front face of component 10. The angular interval, over which the first engagement surface 34 extends, is larger than 90°, so that the first engagement surface 34 rises before reaching the transition region 36. In the illustrated example, the angular interval of the second engagement surface 38 is smaller than 90°, wherein by placing the center line E of the second circular cylinder, whose radius R2 is larger than the radius R1 of the first circular cylinder, between the center line A and the right end of component 10, starting from the right edge of the recess 30, the distance between the second engagement surface 38 and the upper side of component 10 initially increases. Due to the eccentric arrangement of the circular cylinders, the distance between the engagement surfaces 34 and 38 increases with increasing distance from the right end of component 10.

In FIGS. 2b)-d), it is illustrated how the component 12 with its projection 32 is initially inserted into the recess 30 and is then further inserted into the component 10 while being guided by the engagement surfaces on the corresponding opposing surfaces and then is downwardly (clock-wise direction) pivoted. The clearance between the corresponding engagement surfaces thereby increasingly decreases with increasing downward-pivoting due to the eccentric arrangement of the circular cylinders, until a clearance-free engagement is achieved in the fully-downward pivoted state; this engagement prevents vertical relative-movement between the components 10 and 12 as well as prevents a separation of the components 10 and 12 within a horizontal plane.

In this illustrated example, the engagement surfaces are also not required to be parts of circular cylinders. It is only important that the respective concavities and convexities correspond and an undercut is provided relative to the separating movement in the state according to FIG. 2. The depth of the recess 30 can be greater than the length of the projection 32, so that a cavity may remain in the area of the transition region 36 in the fully downward moved state.

In the embodiments according to FIGS. 1 and 2, different tools or at least different milling adjustments are necessary for the manufacture of the projection(s) and the recess. The components 10 and 12 are overall different.

Embodiments will be explained with the assistance of FIGS. 3-6, with which both components, which are again provided with the different reference numbers 10 and 12, and/or their projections are the same as each other and, in the illustrated state, both components can be transposed into each other by rotating one component by 180° about an axis that is perpendicular to the drawing plane and by a subsequent translational displacement.

The component 10 of FIG. 3 has a projection 39, which is the same as projection 39′ formed on component 12. When the component 12 is rotated by 180° about an axis extending perpendicular to the drawing plane, it can be made conterminous with component 10 by translational displacement.

The projection 39 is similar to the projection 14 of FIG. 1, which is formed by a recess 20 that transitions into an elevation 24.

The contour of the projection 14 is set such that the upper side of the component 10 transitions via a first engagement surface 40 into the concave upper side of the recess 20. The first engagement surface 40 is a section of a circular cylinder having the center line A and the radius R, wherein the center line A lies below the upper side of component 10. The convex, first engagement surface 40, which extends over an angular interval of less than about 45° in the illustrated example, projects somewhat into the area over the projection 14 due to its curvature. The first engagement surface 40 transitions into the concave upper side of the recess 20, which forms a second engagement surface 42 that extends over an angular interval of almost 180° of a circular cylinder having the center line B and the radius r. The second engagement surface 42 transitions into a third engagement surface 44 that forms the upper side of the elevation 24; the second engagement surface 42 extends over an angular interval of substantially about 180° of another circular cylinder having the center line C and the same radius r as the radius of the second circular cylinder. The third engagement surface 44 transitions into a fourth engagement surface 46, which is a section of a circular cylinder having the center line D and the same radius R as the first circular cylinder.

As illustrated, the connection line between A and D extends, in the illustrated interlocked state of components 10 and 12, from the upper left diagonally towards the lower right; the center lines B and C of the two circular cylinders with the radius r advantageously lie approximately on this connection line. The projection 14 is advantageously provided with a slot 48 extending outward in the portion of the elevation 24 of the third engagement surface 44. Similarly, the corresponding projection of component 12 is provided with a slot.

The attachment of the two components 10 and 12 to one another can take place in two types of ways. In the Figure parts 3b) and 3c), it is illustrated how the component 12 in the upwardly-pivoted state can be moved near to the first engagement surface, in order to then be downwardly pivoted while being guided by the first engagement surface and the corresponding opposing surface, until the state according to FIG. 3 is achieved. In the state of FIG. 3, the component 12 can not be moved towards the right relative to component 10 due to the existing undercuts. In addition, the component 12 can not be displaced upwardly in the vertical direction relative to component 10 due to the undercuts in the region of the first engagement surface 40 and the fourth engagement surface 46. In this context, the second and third engagement surfaces form substantially only abutment surfaces.

According to Figure parts 3d) and 3e), after the component 12 is moved from the right into abutment on the upper end of the first engagement surface 40 and the fourth engagement surface 46, the component 12 can be moved downward substantially in the vertical direction relative to component 10, wherein, due to the slots provided in the elevations, the elevations of the projections are somewhat elastically deformed when passing over the undercuts; the undercuts are provided by the convexities of the first engagement surface 40 and the fourth engagement surface 46. The size of the slot 48 conforms to the mechanical properties of the material of the component.

Again, in the embodiment according to FIG. 3, the engagement surfaces are not required to be segments of circular cylinders, as long as the described concave and convex shapes and undercuts are ensured.

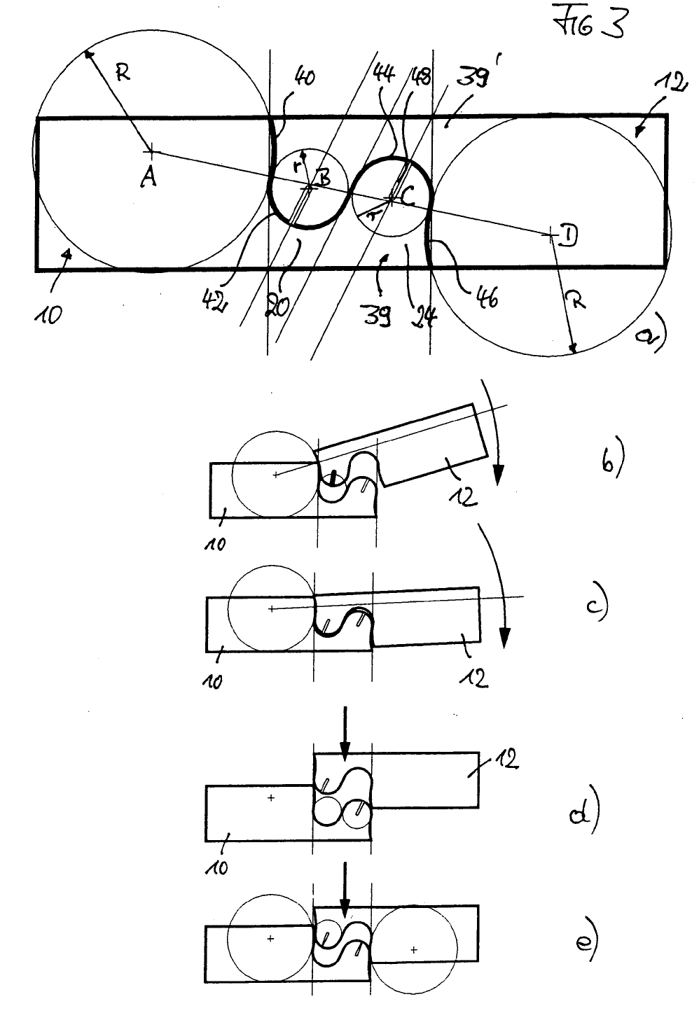

FIG. 4 shows a variation of FIG. 3. The first engagement surface 40 and the fourth engagement surface 46 are formed substantially as in FIG. 3. The upper sides of recess 20 and the recess 24 are, however, formed as substantially planar surfaces 50 and 52 that transition into each other and into the engagement surfaces via advantageously circular-cylindrically curved areas. The radii of the circular cylinders are small relative to the radii of the circular cylinders of the engagement surfaces 40 and 46. The curved transition regions 54 between the different sections respectively extend via circumferential angles of more than 90°, so that another undercut 56 exists in the transition region between the recess 20 and the elevation 24; the undercut 56 prevents vertical relative movement between the components 10 and 12. The elevation 24 is again provided with a slot 48.

In Figure part 4b), it is illustrated how the component 12 can be attached to component 10 by downward-pivoting about the center line A. The undercut 56 thus must be overcome by deformation. In Figure part 4c), it illustrated how the component 12 can be interlocked with component 10 by vertical-sliding downwardly, wherein the undercuts are again overcome by elastic deformations that are facilitated by the slot 48 formed in the elevation 24 near the transition to the recess 20.

The embodiment of FIG. 5 differs from the embodiment of FIG. 4, in that an oblique surface 56 is formed in the transition between the recess 20 and the elevation 24; the oblique surface 56 is inclined by more than 20° relative to the upper side of the recess 20 and the oblique surface 56 transitions via curved regions into the upper sides of the recess 20 and the elevation 24, which are formed as planar surfaces 50 and 52. In this case, the slot 30 is advantageously formed in the portion of the planar surface 52 that is near to the fourth engagement surface 46. The curvatures of the first engagement surface 40 and the fourth engagement surface 46 are, in the illustrated example, sharper than in the embodiments according to FIGS. 3 and 4.

As illustrated in FIGS. 5b) and 5c), the component 12 can also be attached to component 10 by pivoting or by vertical downward-movement, wherein the undercuts are overcome by deformations that are facilitated by the slot 30.

In the embodiment according to FIG. 5, the transition regions from the first engagement surface 4 and the fourth engagement surface 46 to the adjacent regions are advantageously less sharply curved than the transition regions between the oblique surface 56 and the adjacent portions.

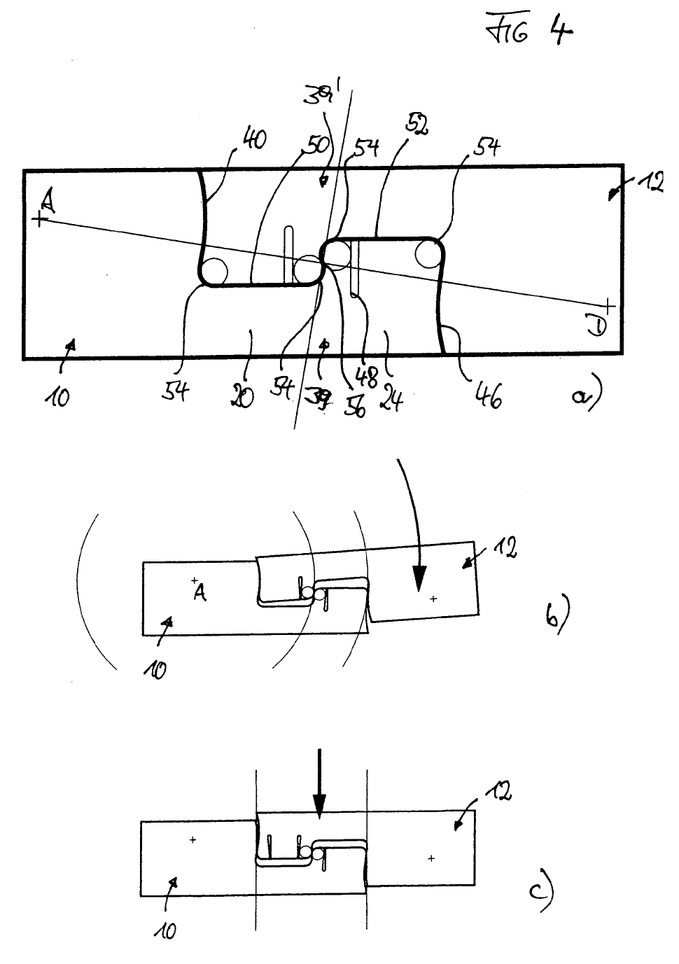

The embodiment of FIG. 6 differs from the embodiment of FIG. 5, in that the curvatures of the transition regions 54 are approximately the same and the first engagement surface 60 and the corresponding fourth engagement surface 64, which achieve a form-fit in the vertical direction, are not formed as surfaces that are overall convex or concave, but rather are each formed with a short undercut surface 64 and 66, respectively. The first engagement surface 60 extends obliquely from the upper side of the component 10 initially approximately perpendicular to the projection 14 and then transitions via a short undercut surface 64, which extends obliquely downwards away from projection 14, in order to then transition via the transition region 54 into the planar surface 50 of the recess 20. The second engagement surface 62 is correspondingly formed with the undercut surface 66.

As is apparent from FIG. 6b), the component 12 can be interlocked with component 10 by vertical downward-movement, wherein the elevation 24 is passed over by overcoming the undercut while deforming the advantageously-provided slot 48.

It is understood that, when the components 10 and 12 are not end parts at the side edges of a flooring or a paneling, but rather are middle parts, these components are formed such that, e.g., the right edge of the component 10 is formed with the projection 14, and the left side is formed with projection 16. In this way, a surface can be laid from left to right, whereby the right-side connecting component is joined and downwards pivoted or, as much as the described connection system makes it possible, merely moved downwards. Connection systems, which require an interlocking and/or a mutual attachment of the components to take place while pivoting, only permit an interlocked connection of the components in an installation direction. This is illustrated in FIG. 7a). The parquet elements 70, 71, and 72 have been already connected together. When the connection system permits a connection only while pivoting, as the example of the to-be-attached parquet element 73 illustrates, this element must initially be pivoted downwards and then slid into the element 72 into the state of the form-fit connection with the element 70 and must be attached to this element in a friction-fit manner, e.g., by means of a simple groove-tongue-connection, or with supplemental gluing.

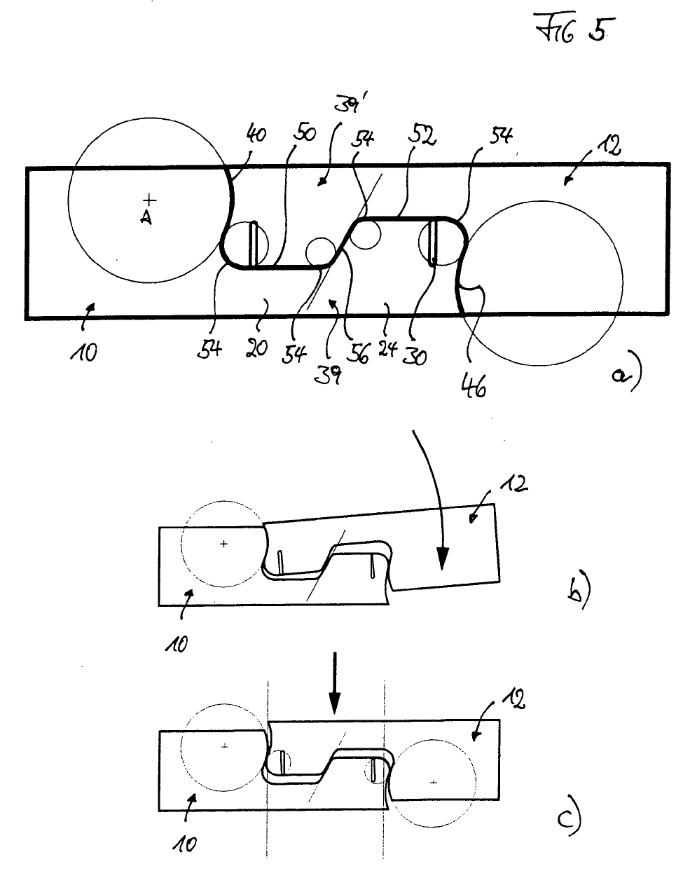

The inventive system and/or components according to FIGS. 1 and 2 allow a connection merely by pivoting. The systems according to FIGS. 3, 4 and 5 allow a connection by pivoting or by a linear downward-movement. When an edge portion according to FIGS. 1-5 is provided on a longitudinal edge of an element 70 and 73, a downward-pivoting similar to FIG. 7a) is possible. When an edge portion according to one of FIGS. 3-6 is provided on a front side or a width side of the elements, the element 73 can be laid in its intended final position on the element 70 and, by using one of the end portions according to FIGS. 1-5, can be pivoted downwards about its longitudinal edge and, by using an edge portion according to FIGS. 3-6, the front face can be directly brought into a form-fit also with element 73 by downward-pivoting (cf. FIG. 7b)). When an edge portion according to FIGS. 3-6 is employed on the longitudinal edges and the front edge, the element 73 can be directly brought from above into a form-fit connection with the adjacent elements 70 and 72 (cf FIG. 7c)). In this way, the invention ensures the direct form-fit installation of a wide variety of parquet shapes, as illustrated in FIG. 8, by an appropriate combination of the described components and/or connection systems.

The invention further makes possible the installation of floor configurations that were formerly reserved to tiles: By being able to install inventive parquet elements by means of adding a further element only with vertical movement relative to a floor, parquet elements can be laid in any desired geometric configuration, as long as they are provided with edge portions according to FIGS. 3-6; surfaces can be closed with such elements as illustrated. In FIG. 9, the left half shows individual parquet elements having a wide variety of shapes. The right half of FIG. 9 shows patterns producible from the elements illustrated on the left-side.

By constructing the components and/or the parquet elements in the illustrated example with uniformly-formed, projecting edge portions in the embodiment of the edge portions according to FIGS. 3-6, further installation possibilities result:

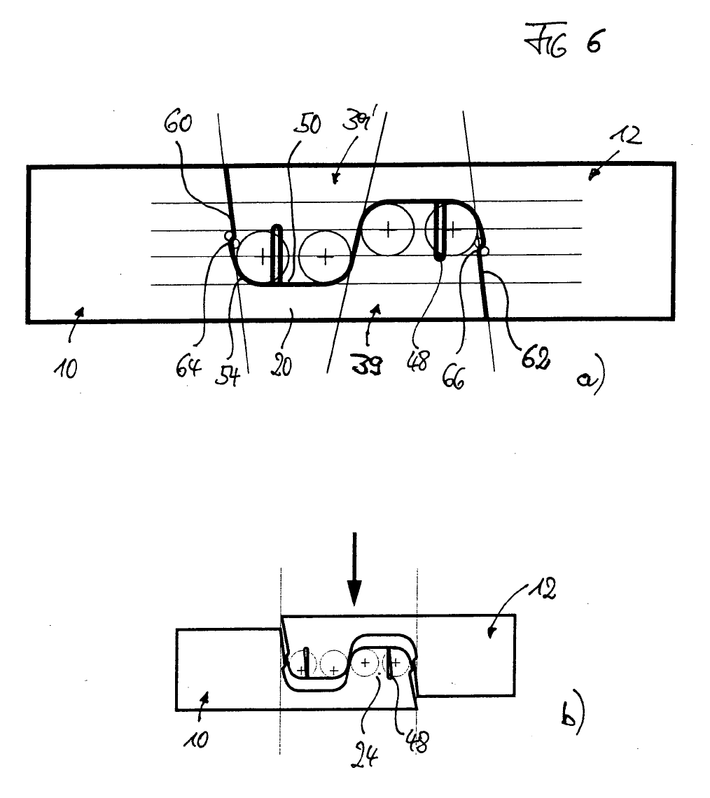

In part a) left, FIG. 10 shows a rectangular parquet element that is provided on its lower and right edges with edge portions projecting from the underside and is provided on its upper and left edges with edge portions projecting from the upper side. By rotating, the parquet element 70 can be brought into the right position in FIG. 10a), in which its underside has become its upper side and the upper and right edges are provided with edge portions projecting from the underside and the under and left edges are provided with edge portions projecting from the upper side.

FIG. 10b) shows how the parquet elements, which are illustrated in Fig. a) left, can be connected together using the installation-direction from left to right, whereas the parquet elements, which are illustrated in FIG. 10a) right, can be laid from right to left with a transposed upper side.

FIG. 10c) shows how the elements 70 with differing upper sides can be laid in a mixed manner.

FIG. 11 shows similar possibilities for square parquet elements.

The inventive edge portions, which are formed to be identical with each other, thus make possible an arrangement of the parquet elements with the underside facing upward or with the upper side facing upward, so that various patterns can be laid when the under and upper sides are appropriately constructed with uniform parquet elements.

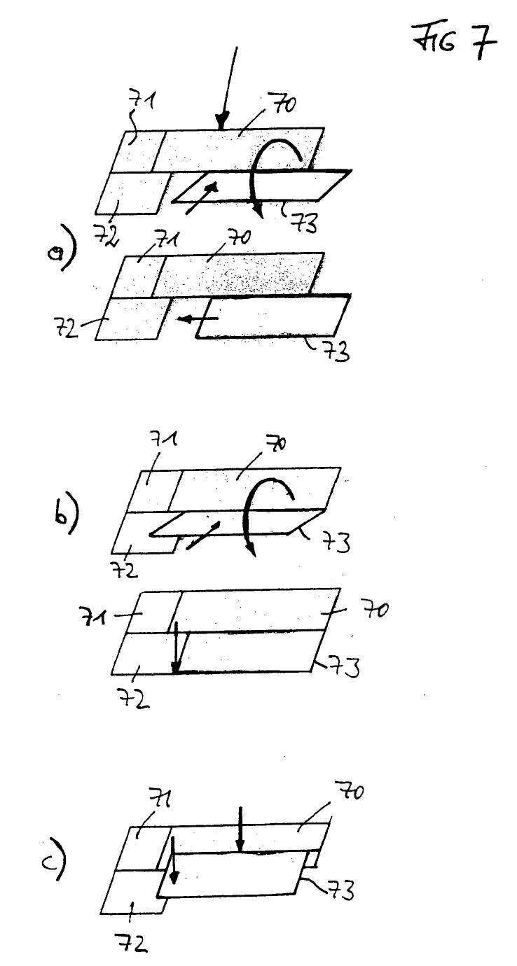

FIG. 12 clarifies how it is possible with the inventive, freely installable elements having differing templates, provided that these cover a closed surface, to assemble floor elements, which are previously imprinted with pattern elements, into a completed aggregate, wherein during printing of the individual elements with the pattern, the elements are advantageously marked, e.g., on their underside or at a front face in accordance with their future installation location within the pattern.

FIG. 13 shows a further example of a pattern, which is producible with parquet elements having different sizes using a form-fit engagement, when the elements are provided with inventive edge portions. Thus, the left and upper edges of a component advantageously always include a projection, which projects from above and/or extends flush with the upper side; the right and lower edges of an already-laid component always include a projection projecting from its lower half.

The components provided with the inventive edge portions can be of a wide variety of types. For example, one or both sides of parquet elements made of solid wood, of inexpensive core, of a fiber material or a particulate material, can be formed by lamination, veneer, printing, etc. All in all, the invention creates new possibilities for designing floors, paneling, etc. using glue-free, form-fit connection of individual elements that form a form-fit, interlocked bond in the installed state.

The manufacture of the inventive connection portions and/or edge portions is extraordinarily simple, in particular when the edge portions have a uniform cross-section.

FIG. 14 shows an example for manufacturing the edge portion of a component 10, whose projection 39 is formed similar to the example of FIG. 5. Four milling heads and/or milling cutters 72, 74, 76, 78 are illustrated, which are rotatably driven about a stationary axis and under which the component 10 proceeds in the direction of the arrow. The contour of milling cutter 72 corresponds to the engagement surface 40 and the transition region 54. The planar surface 50 and the oblique surface 56 are milled with milling cutter 74. The milling cutter 76 mills the surface 52. The milling cutter 78 mills the engagement surface 46 and the transition region 54, which is between the engagement surface 46 and the planar surface 52. In the illustrated example, the transition regions between the oblique surface 56 and the planar surfaces 50 and 52 are beveled. For the case that curvatures are also provided there, as in the example of FIG. 5, the overall conical outer surface of milling cutter 74 is contoured accordingly. It is understood that the projection 39 on the component 10 can also be formed such that the component 10 is fixedly held and the arrangement of the four milling heads is moved relative to the component.

Further advantageous details of the components will be explained with the assistance of the following Figures, which components are detachably-affixable similar to the exemplary embodiments according to FIGS. 3-6, in particular by moving perpendicular to its direction of extension.

According to FIG. 15, a component 10, a part of which is shown in cross-section, having a flat upper side and a flat lower side includes a projection 14; the free end of the projection 14 is formed with an elevation 24 that transitions via a recess 20 into the intrinsic body of the component 10.

The side surface of the elevation 24, shown on the left in FIG. 15, initially extends at approximately a right-angle to the upper side of the component 10, then projects a little bit towards the left and then transitions into the head of the elevation, which head is convex in cross-section, in order to then transition into the concave recess 20. As is apparent, the head of the elevation 24 is slightly thickened at 80, as viewed in the longitudinal direction of the component. The maximal thickness d1 of the elevation 24 and the minimal thickness d2 of the recess 20, as respectively measured perpendicular to the upper surface of the component 10, are advantageously set such that the sum of d1 and d2 is a little bit less than the entire thickness d3 of the component 10.

The outer contour of the elevation 24 is such that it fits precisely into the inner contour of the recess 20, with the exception of a clearance remaining due to the thickness relationship.

In FIG. 16 it is illustrated how a component 10 is connected with a component 12, which is rotated by 180° but is exactly the same as component 10. Due to the thickness relationship explained with the assistance of FIG. 1, a clearance 82 remains between each projection of one component and each recess of the other component, in which possible dust particles can be accommodated without negatively influencing the connection to each other. As a consequence of the thickening 80, an undercut exists in the vertical direction; when the components are connected, wherein the component 10 is pushed from above in the vertical direction onto the projection of the component 12, the undercut is overcome by at least partial elastic deformation of the projections and provides a connecting form-fit between the components 10 and 12 with respect to a vertical relative movement.

The thickening 80 is not required to be formed on both sides of the elevation 24, but rather can be provided only on the side of the recess 20, so that the front surface, which is on the left side according to FIG. 1, is planar. With this, it is achieved that this portion of the front surface of the component 10 is not required to be processed during manufacture of the projection.

In the connected state of the components 10 and 12, the vertical and undercut surfaces are in mutual abutment without tension, so that a not-tensioned, clearance-free, form-fit connection exists between the components 10 and 12.

In the illustrated embodiment, the two components 10 and 12 are advantageously detachably-connectable merely by being moved one on top of the other perpendicular to their extension. The front surface of the projection, shown on the left in FIG. 15, can be formed concave, wherein the lower, left front surface of the body of the component 10, which borders the recess 20 to the right according to FIG. 15, is then formed concave in a corresponding manner. In this case, the component 10 can be positioned on the component 12 vertically as well as can be initially inserted from above according to FIG. 16 oblique from above, wherein the front surfaces are in planar abutment and form a joint; the component 10 can be downwardly pivoted about the joint into the position shown in FIG. 16.

For improved deformability, the thickening of the elevation 24 can be slotted.

FIG. 17 shows a somewhat different embodiment of a projection 14 as compared to FIG. 15. The upper side of the component, which is illustrated on the left in FIG. 17, transitions via a slightly rounded and/or convex shaped surface 86 into the concave recess 20, which transitions into the convex elevation 24; the convex elevation 24 then transitions via a concave shaped surface 88, which is formed complementary to the convex shaped surface 86, into the underside of the component 10. As illustrated by the arrow, the component 10 illustrated on the right-side is producible from the left-side component by rotating about 180°. The component 12 can be connected with the component 10 either by vertical movement one on top of the other according to the Figure or by initially oblique positioning and then downward pivoting. In the connected state, the outer surfaces of the projections are in form-fit, mutual, planar abutment.

FIGS. 18 to 20 illustrate different embodiments of flat components in cross-section and/or in top view.

In the component 10 according to FIG. 18, the left-side projection 14 prolongs the upper side of component 10 and the right-side projection 16 prolongs the lower side of component 10. The projections are the same as each other and can be transposed into each other by rotating by 180° around an axis perpendicular to the drawing plane.

In the component 10 according to FIG. 19, both projections 14 and 16 prolong the upper side of the component 10 and are transposable into each other by rotating by 180° around an axis extending perpendicular from the drawing plane, as well as by rotating by 180° around an axis extending perpendicular to the upper side of the component 10.

As is further apparent from the Figures, the projections are each made so that they substantially completely fill the volumes covered by them, while not retaining a clearance according to FIG. 16 if desired, in the pushed-together state, so that a form-fit exists in the vertical as well as the horizontal direction.

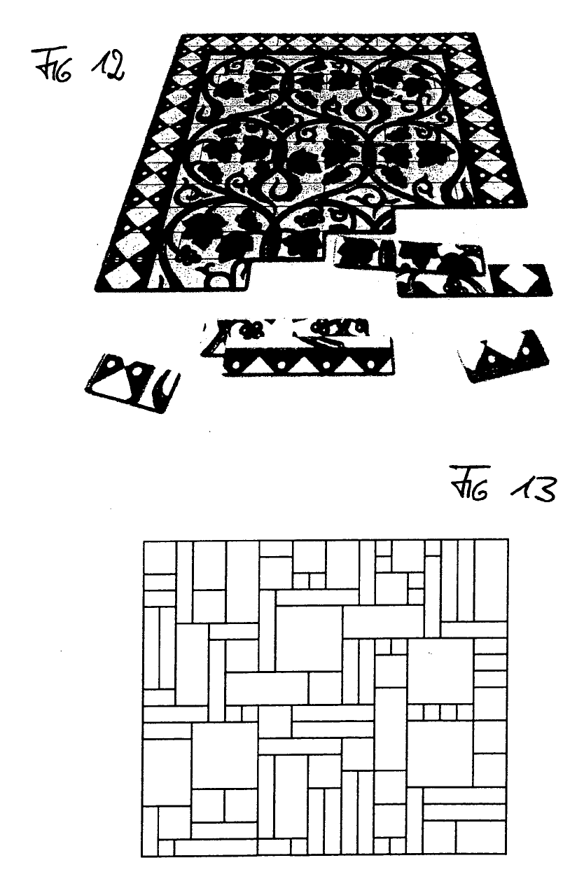

The embodiment of the component 10 according to FIG. 20 differs from the embodiment of FIG. 19, in that both projections 14 and 16 project from the underside and/or the lower half of the component 10.

FIG. 21 shows two different embodiments of components. In the component 10 illustrated on the left, the left and upper edges are provided with a connecting projection, which projects from the lower half of the component 10, whereas the right and lower edge are provided with a connecting projection, which projects from the upper half of the component 10.

On the other hand, in the component 10 illustrated on the right in FIG. 21, the oppositely-disposed edges are provided with corresponding projections 14.

All in all, as was already illustrated in an exemplary manner with the assistance of FIGS. 10 and 11, different possibilities for the design of the components are provided for the construction of the profiled projections, by means of which the components can be detachably affixed to each other. The projections can be formed to peripherally project only from the upper half or only from the lower half. Each top layer remains fully maintained. There is no cutting loss and the top layer remains fully usable.

At least one edge portion of the component is provided with a projection on its upper side, whereas another edge portion is provided with a projection on its underside.

In this way, a wide variety of components can be connected together to make a wide variety of patterns, wherein it is also possible to assemble a pattern from the same components having different upper and lower sides. Due to the components being connectable merely by relative movement perpendicular to their flat extension, it is possible with an appropriate design of the edges to exchange components in an interior region of an installed pattern in a simply way without having to work from the edge of the pattern.

For the manufacture of upper surfaces of a wide variety of outer appearances, it is advantageous if the inventive components have an inkjet-compatible upper surface made of paper on their upper and/or lower side. The paper can be laminated on the respective upper surface of the component, advantageously, by choosing the connecting and/or adhesive layer, which cures after applying to the paper, such that it does not fully penetrate the paper in the liquid state, so that the free paper upper surface is provided in an absorbent output state. An inkjet-compatible upper surface condition can be advantageously achieved by making the component, e.g., as a layered body having an upper surface made of wood veneer, which is brought into an inkjet-compatible condition, in which it advantageously has a certain amount of absorbency.

The components provided with the inventive connecting projections can be formed in a multi-layered manner or can be formed, e.g., as a composite body, as will be described with the assistance of FIGS. 22 to 25.

In the embodiment according to FIG. 22, the component provided with the projections 14 and 16 is a composite component, with which the projections 14 and 16 as well as the upper side form a supporting shaped-body 92, in which a functional component is also employed that forms the underside of the component 90 and is made of heat-insulting, sound-insulating or other material.

In the embodiment according to FIG. 23, functional components and/or functional bodies 94 are fully encased by the shaped-body 92.

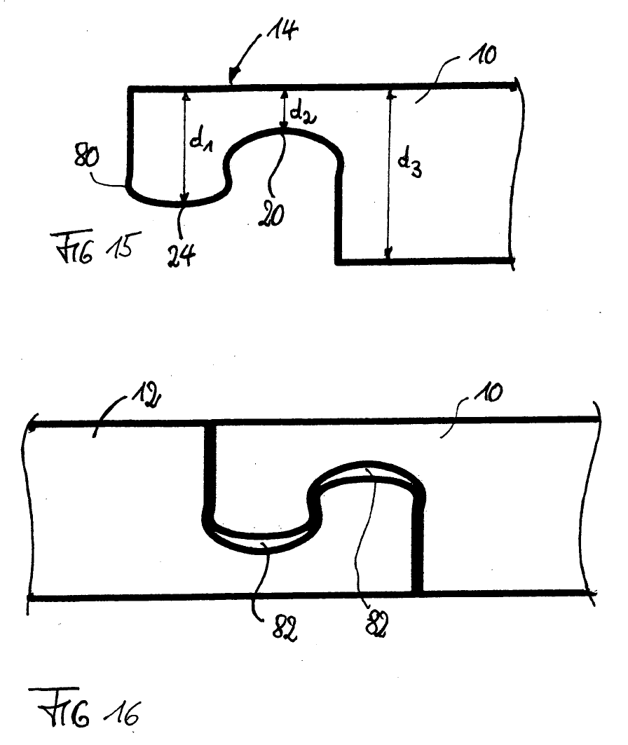

In the embodiment according to FIG. 24, the shaped-body 92 is provided with downward-opening grooves; functional materials and/or functional components 94 are inserted into the grooves.

In the embodiment according to FIG. 25, grooves 96 or recesses formed in the shaped-body 92 are formed such that their cross-section increases in the direction towards the upper side of the component 90, so that a form-fit exists between the functional component 94 and the shaped-body 92. If the functional component 94 is comprised, e.g., of curable material, the fixed connection between the shaped-body 92 and the functional component 94 can be produced by the curing of its material.

The functional component(s) and the corresponding materials can fulfill a wide variety of functions. For example, the functional material can be a pure filling material, e.g., glass wool, which is inexpensive, has a low weight, and has noise-damping or sound-absorbing as well as heat-insulating or also good heat-conductive properties.

As is readily apparent from FIG. 22 to 25, the component provided with the connecting projections can be produced in an extrusion process, even if it is formed as multi-layered or as a composite body.

FIG. 26 shows an example of two components 90 and 92, whose upper sides are comprised, e.g., of stone, ceramic, synthetic material, wood or also carpet; these components 90 and 92 do not contribute to the form-fit and detachable connection, because this connection is achieved by the projections 14 and 16, which is formed by the intrinsic support structure.

FIG. 27 clarifies how components 90 and 92 constructed from different layers can nevertheless be produced with the same thickness, so that their upper surfaces align and the projections 14 and 16 are merely comprised of the material of the support structure.

FIG. 28 shows an example of a component 100, which is provided with the projections 14 and 16 and has a downwardly-projecting strut 102; an accessible threaded rod 104 protrudes from above through a hole in the strut 102 and ends in a foot 106.

FIG. 29 clarifies how a wood floor can be assembled from components 100 according to FIG. 28; cables, wires, etc. can be laid under the components. Each threaded rod 104 is accessible to adjust the height thereof, before a new component is attached.

FIG. 30 shows a further embodiment of an inventive component 110, which is provided on its underside with an electrically-conductive layer 112 that protrudes inward on the sides up to the shaped surface of the projections 14 and 16. By embodying the electrically-conductive layer 112 in this manner, it is ensured, as shown in FIG. 31, that the electrically-conductive layers 112 arrive in an electrically-conductive contact when the components 110 are connected, so that they, e.g., shield a floor or a wall with respect to electromagnetic waves. A voltage source is denoted with 114 in FIG. 31, with which the correspondingly-formed, electrically-conductive layer, which can, e.g., form individual conductive paths, is supplyable with current. The component 110 according to FIG. 30 can be modified in a not-illustrated manner, in that a plurality of electrically-conductive layers or conductive paths are provided, which are isolated from each other, but come into electrical contact when the components are attached to each other.

The struts 102 according to FIG. 29 can include openings or can stretch over the entire length of the component 100, so that wires can also be laid transverse to the struts.

The above-described exemplary features can be modified in various ways and also can be combined with each other on individual as well as different components.

### REFERENCE NUMBER LIST

10 Component
12 Component
14 Projection
16 Projection
18 First engagement surface
20 Recess
22 Second engagement surface
24 Elevation
26 Third engagement surface
30 Recess
32 Projection
34 First engagement surface
36 Transition region
38 Second engagement surface
39 Projection
40 First engagement surface
42 Second engagement surface
44 Third engagement surface
46 Fourth engagement surface
48 Slot
50 Planar surface
52 Planar surface
54 Transition region
56 Oblique surface
60 First engagement surface
62 Second engagement surface
63 Undercut surface
66 Undercut surface
70 Parquet element
72 Milling cutter
74 Milling cutter
76 Milling cutter
78 Milling cutter
80 Thickening
82 Clearance
86 Shaped surface
88 Shaped surface
90 Component
92 Shaped-body
94 Functional component
96 Groove
98 Layer
100 Component
102 Strut
104 Threaded rod
106 Foot
110 Component
112 Layer
114 Voltage source

1-35. (canceled)

36. A generally flat component for covering a substantially-planar substrate, comprising:
a generally flat body having an upper surface and a lower surface, and
a projection laterally extending from the generally flat body and having an upper surface and a lower surface, wherein one of the upper and lower surfaces of the projection has a substantially concave recess closest to the generally flat body and a substantially convex elevation closest to a terminal end of the projection and the other of the upper and lower surfaces of the projection extends in a substantially flush manner with the corresponding upper or lower surface of the generally flat body,
wherein at least one engagement surface is defined on each of the recess and elevation of the projection and each engagement surface extends generally perpendicularly to an extension direction of the projection, the engagement surfaces being configured such that:
the engagement surfaces are bringable into a form-fit engagement with a second generally flat component having a complementarily-formed projection,
the projections of the respective generally flat components are disposable one on top of the other in the form-fit engagement, and
the respective engagement surfaces prevent the engaged components from separating in a direction parallel to the extension direction of the projection,
wherein at least two of the engagement surfaces have an undercut defined thereon, the undercuts being configured to be passed over, while at least one of the recess and elevation undergoes elastic deformation, by respective oppositely-directed undercuts formed on the corresponding engagement surfaces of the to-be-engaged complementary projection when the two components are engaged by moving the components relative to each other in a direction substantially vertical to the extension direction of the projection, and
wherein the respective undercuts are configured to detachably-secure the two engaged components from separating in the direction vertical to the extension direction of the projection.

37. A component according to claim 36, wherein:
the substantially concave recess extends over a circumferential angular interval of about 180°, the recess having a surface that is oppositely curved relative to the engagement surface defined on a generally vertically-extending side of the recess, and
the substantially convex elevation extends over a circumferential angular interval of about 180°, the elevation having a surface that is oppositely curved relative to the engagement surface defined on a generally vertically-extending side of the elevation.

38. A component according to claim 36, wherein a generally vertically-extending surface is defined on the projection between the substantially concave recess and the substantially convex elevation, said generally vertically-extending surface including an undercut configured to pass over, while at least one of the recess and the elevation elastically deforms, a complementarily-formed undercut on the projection of the complementarily-formed component when being form-fitted together and thereby being configured to further detachably-secure the engaged components from separating in the direction vertical to the extension direction of the projection.

39. A component according to claim 36, wherein a generally oblique surface is defined on the projection between the substantially concave recess and the substantially convex elevation.

40. A component according to claim 36, wherein at least one slot is defined in the substantially convex elevation, the at least one slot extending generally in a direction parallel to at least one engagement surface and being configured to facilitate elastic deformation of the elevation when two components are pressed together.

41. A component according to claim 36, wherein at least one of the engagement surfaces has a circular-cylinder-segment shape.

42. A component according to claim 41, wherein each engagement surface has a circular-cylinder-segment shape.

43. A component according to claim 36, wherein at least one of the substantially concave recess and the substantially convex elevation includes a substantially planar surface defined therein, the substantially planar surface extending parallel to the extension direction of the projection.

44. A component according to claim 36, wherein the recess and elevation are configured to achieve a form-fit engagement that is substantially free of elastic tension when two components are engaged.

45. A component according to claim 36, wherein the component is polygonal-shaped and has two identically-shaped projections defined on one of: (i) bordering edges of the polygon and (ii) opposing edges of the polygon.

46. A kit for covering a generally-flat substrate by detachably-attaching a plurality of generally-flat components, the kit comprising:
a first generally-flat component comprising:
a body having an first-generally planar surface extending in parallel with a second generally-planar surface, a vertical height being defined between the first and second generally-planar surfaces and
a projection laterally extending from the body, the projection including a first generally-planar surface extending in a planar relationship with the first generally-planar surface of the body and a second surface having a generally concave recess disposed closest to the body and a generally convex elevation disposed closest to a terminal end of the projection, the elevation having a vertical height that is less than the vertical height of the body,
a generally-flat second component comprising:
a body having an first-generally planar surface extending in parallel with a second generally-planar surface, a vertical height being defined between the first and second generally-planar surfaces and
a projection laterally extending from the body, the projection including a first surface having a generally concave recess disposed closest to the body and a generally convex elevation disposed closest to a terminal end of the projection, the elevation having a vertical height that is less than the vertical height of the body, and a second generally-planar surface extending in a planar relationship with the second generally-planar surface of the body,
wherein the projections of the first and second components are configured to provide a form-fit engagement when pressed together with the projections of the first and second components being disposed one on top of the other, the respective recesses and elevations being configured to detachably-secure the first and second components against separation of the first and second components in a direction parallel to the extension direction of the projections and the projections being configured such that the first surfaces of the first and second engaged components extend in a flush manner and the second surfaces of the first and second engaged components extend in a flush manner, and
wherein the first and second components each have at least a first engagement surface, which extends generally vertically between one planar surface of the body and the recess of the projection, and a second engagement surface, which extends generally vertically at the terminal end of the projection between the other planar surface of the body and the elevation of the projection, the first and second engagement surfaces of the first component each including at least one of a convex undercut and a concave undercut configured to be passed over, while undergoing elastic deformation of at least a portion of the projection, by at least one oppositely-directed undercut formed on the corresponding first and second engagement surfaces of the second component, the respective undercuts being configured to secure the first and second components, when in the form-fit engagement, from separating in a direction vertical to the extension direction of the projections.

47. A kit according to claim 46, wherein at least the projections of the first and second components have identical contours when transposed onto each other.

48. A kit according to claim 46, wherein the generally concave recess of each projection extends over a circumferential angular interval of about 180° and is oppositely curved relative to the first engagement surface, and the generally convex elevation of each projection extends over a circumferential angular interval of about 180° and is oppositely curved relative to the second engagement surface.

49. A kit according to claim 46, wherein a generally vertically-extending surface is defined on each projection between the generally concave recess and the generally convex elevation, the generally vertically-extending surface including an undercut configured to pass over a complementarily-formed undercut on the second component, while at least a portion of the projection undergoes elastic deformation, when being form-fitted together in the direction vertical to the extension direction of the projections, the undercuts thereby being configured to further detachably-secure the first and second components from separating in the direction vertical to the extension direction of the projections.

50. A kit according to claim 46, wherein a generally oblique surface is defined on each projection between the generally concave recess and the generally convex elevation.

51. A kit according to claim 46, wherein at least one slot is defined in the generally convex elevation of each projection, the at least one slot extending generally in the direction vertical to the extension direction of the projection and being configured to facilitate elastic deformation of the elevation when the first and second components are pressed together.

52. A kit according to claim 46, wherein at least one of the first and second engagement surfaces has a circular-cylinder-segment shape.

53. A kit according to claim 52, wherein at least one of the recess and elevation has a circular-cylinder-segment shape.

54. A kit according to claim 46, wherein at least one of the generally concave recess and the generally convex elevation of each projection includes a substantially planar surface defined therein and extending parallel to the first and second surface of the generally-flat body.

55. A kit according to claim 46, wherein the recess and elevation of each projection are configured to achieve a form-fit engagement that is substantially free of elastic tension when the first and second component are engaged.

56. A kit according to claim 46, wherein the first and second components are polygonal-shaped and have two identically-contoured projections, the two identically-contoured projections of the first component being defined on bordering edges of the polygon and the two identically-contoured projections of the second component being defined on opposing edges of the polygon.

57. A kit according to claim 46, wherein at least one planar surface of the generally-flat body and the projection of the first component is comprised of a material selected from the group consisting of stone, ceramic, synthetic material, wood and carpet and at least one planar surface of the generally-flat body and the projection of the second component is comprised of a different material selected from the group consisting of stone, ceramic, synthetic material, wood and carpet, said planar surfaces comprised of different material being flush when the first and second components are engaged.
